(19) United States
(12) Patent Application Publication
(10) Pub. No.: US 2026/0308074 A1
(43) Pub. Date: Oct. 8, 2026

(54) BONDED REINFORCED PLASTIC CONCRETE VAPOR BARRIER

(71) Applicant: Helix Steel, LLC, Ann Arbor, MI (US)

(72) Inventor: Luke Pinkerton, Ann Arbor, MI (US)

(21) Appl. No.: 19/485,700

(22) PCT Filed: May 14, 2024
(86) PCT No.: PCT/US2024/029185

§ 371 Date: Nov. 19, 2025

Related U.S. Application Data
(60) Provisional application No. 63/468,832, filed on May 25, 2023.

(51) Int. Cl. C04B 40/06; C04B 41/45; C04B 41/48; C04B 41/53

(52) U.S. Cl. CPC C04B 40/0625; C04B 41/4501; C04B 41/4578; C04B 41/4826; C04B 41/4861; C04B 41/5307

(57) ABSTRACT

A reinforced vapor barrier for application to a concrete structure, a concrete structure containing said reinforced vapor barrier, and a method of forming said concrete structure is provided. The reinforced vapor barrier includes a polymeric sheet and a continuous reinforcement material. The continuous reinforcement material is at least partially embedded within the polymeric sheet with a portion thereof protruding from a surface of the polymeric sheet, such that the protruding reinforcement material interacts with the concrete structure. The interaction of the protruding continuous reinforcement material with the concrete structure connects, joins, bonds, or attaches the reinforced vapor barrier to the concrete structure.

### FIELD

This disclosure relates generally to vapor barriers used in the design and construction of concrete structures. More specifically, this disclosure relates to a reinforced vapor barrier used to provide protection to a concrete slab or wall, as well as to concrete structures that include such reinforced vapor barriers.

### BACKGROUND

The statements in this section merely provide background information related to the present disclosure and may not constitute prior art.

Vapor retarders may be utilized in slab-on-grade applications. These vapor retarders are generally located under a concrete slab in order to control the rate of moisture transmission between the bottom of the slab and the ground or any compacted subgrade layer located on top of the ground. These vapor retarders typically exhibit a permeance to moisture that is on the order of 5.72 nanograms per second per meter squared per Pascal (ng/s-m²-Pa) or 0.1 US perm.

Protection from moisture migration is desirable for most interior concrete slabs because the exposed surface of the slab may be covered by a carpet, tile, wood, or other type of flooring, as well as in situations when moisture sensitive equipment will be placed upon the concrete slab.

In many applications, a fine-grade, crushed granular material (e.g., stone, gravel, etc.) is compacted and used as a subgrade layer located on top of the ground or earth in order to provide additional support for the vapor retarder and the concrete slab. However, even in this situation, the use of rebar or steel reinforcement remains necessary in order to accommodate the overall weight that may be placed upon the concrete slab.

### SUMMARY

The present disclosure generally provides a reinforced vapor barrier for application to a concrete structure. This reinforced vapor barrier comprises a polymeric sheet and a continuous reinforcement material. The continuous reinforcement material is at least partially embedded within the polymeric sheet with a portion thereof protruding from a surface of the polymeric sheet, such that the protruding reinforcement material interacts with the concrete structure.

According to another aspect of the present disclosure, a concrete structure is provided that includes a reinforced vapor barrier as described above and as further defined herein.

According to yet another aspect of the present disclosure a method of forming a concrete structure having a surface with a reinforced vapor barrier is provided. This method generally includes placing a reinforced vapor barrier comprising a polymeric sheet and a continuous reinforcement material in contact with ground, such that a portion of the continuous reinforcement material protrudes from a surface of the polymer sheet that is not in contact with the ground; pouring concrete onto the surface of the polymeric sheet that contains the protruding continuous reinforcement material; and allowing the protruding continuous reinforcement material to interact with the concrete while the concrete cures. The interaction of the protruding continuous reinforcement material with the concrete connects, joins, bonds, or attaches the reinforced vapor barrier to the concrete structure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a schematic showing a cross-sectional representation of a concrete structure comprising a reinforced vapor barrier formed according to the teachings of the present disclosure;

FIG. 1B is a schematic showing a cross-sectional representation of another concrete structure comprising a reinforced vapor barrier formed according to the teachings of the present disclosure;

FIG. 2A is a schematic showing a cross-sectional representation of a reinforced vapor barrier formed according to the teachings of the present disclosure;

FIG. 2B is a schematic showing a cross-sectional representation of another reinforced vapor barrier formed according to the teachings of the present disclosure;

FIG. 2C is a schematic showing a cross-sectional representation of another reinforced vapor barrier formed according to the teachings of the present disclosure;

FIG. 2D is a schematic showing a cross-sectional representation of another reinforced vapor barrier formed according to the teachings of the present disclosure;

FIG. 3A is a top-down view of a reinforced vapor barrier formed according to the teachings of the present disclosure;

FIG. 3B is a top-down view of another reinforced vapor barrier formed according to the teachings of the present disclosure;

FIG. 3C is a top-down view of another reinforced vapor barrier formed according to the teachings of the present disclosure;

FIG. 3D is a top-down view of another reinforced vapor barrier formed according to the teachings of the present disclosure;

FIG. 4 is a cut-away view of a conventional string reinforced polymer sheet product; and

FIG. 5 is a flowchart illustrating a method of forming a concrete structure according to the teachings of the present disclosure.

The drawings described herein are for illustration purposes only and are not intended to limit the scope of the present disclosure in any way.

### DETAILED DESCRIPTION

The following description is merely exemplary in nature and is in no way intended to limit the present disclosure or its application or uses. It should be understood that throughout the description, corresponding reference numerals indicate like or corresponding parts and features.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The objective of the present disclosure is to remedy the aforementioned disadvantages and to provide a superior reinforced vapor barrier for use with a concrete structure. The overall benefit of the reinforced vapor barrier of the present disclosure is that this barrier performs a dual purpose by providing a barrier to moisture migration that is at least as good as, if not better than the vapor retarders currently available along with optimization of structural reinforcement for the concrete structure where it is necessary, e.g., at the bottom of or beneath the slab. The use of a reinforced vapor barrier as described herein eliminates the need for steel reinforcement and/or other forms of reinforcement, which in turn reduces or eliminates both labor and material costs associated with their installation and use. Automated finishing equipment can easily traverse the slabs when a reinforced vapor barrier is utilized without need for rebar reinforcement.

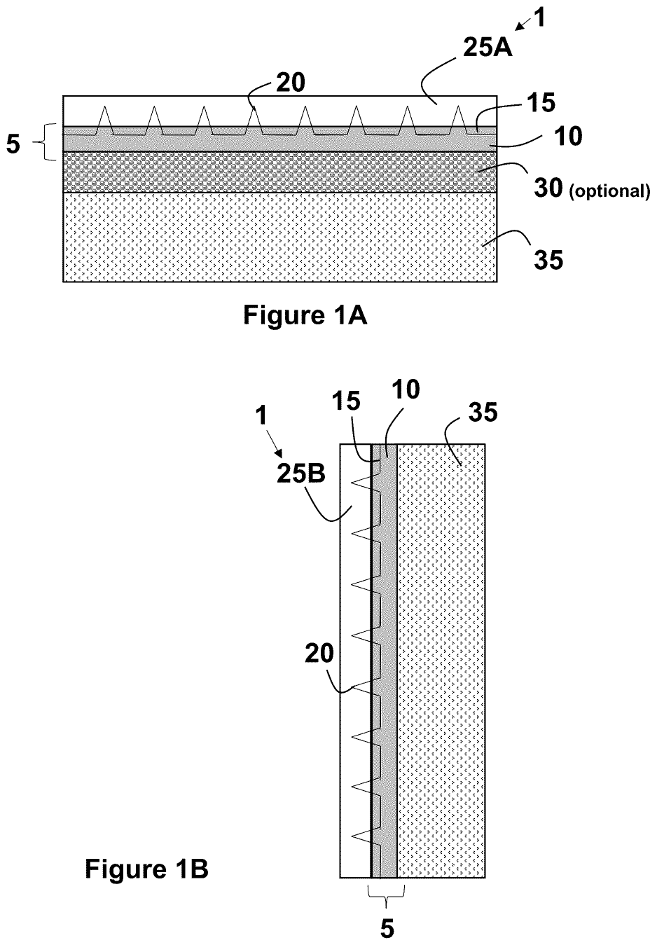

Referring to FIGS. 1A and 1B, the present disclosure generally provides a reinforced vapor barrier 5 for application to a concrete structure 1. This reinforced vapor barrier 5 may comprise, consist of, or consist essentially of a polymeric sheet 10 and a continuous reinforcement material 15. The continuous reinforcement material 15 is at least partially embedded within the polymeric sheet 10 with a portion thereof protruding 20 from a surface of the polymeric sheet, such that the protruding reinforcement material 20 interacts with the concrete slab 25A or wall 25B. The reinforced vapor barrier 5 may be placed on the surface of the concrete structure 1, such that the reinforced vapor barrier 5 separates the surface of the concrete structure 1 from the ground 35. When desirable, a compacted subgrade layer 30 may optionally be placed between the ground 35, e.g., earth, soil, etc. and the reinforced vapor barrier 5.

The reinforced vapor barrier 5 of the present disclosure as made and used according to the teachings contained herein is described throughout the present disclosure in conjunction with a concrete slab 25A (see FIG. 1A) placed upon the ground 35 or an optional subgrade layer 30 in order to more fully illustrate the composition and the use thereof. The incorporation and use of such a reinforced vapor barrier 5 with other concrete structures 1, such as for example, a vertical wall 25B (see FIG. 1B) in which moisture migration and/or reinforcement are of concern is contemplated to be within the scope of the present disclosure. It should be understood that throughout the description, corresponding reference numerals indicate like or corresponding parts and features.

Concrete slabs are typically designed based on plane concrete in accordance with American Concrete Institute ACI PRC-360-10, Chapter 7 wherein capacity is determined based on the initial cracking of the slab under a load. A method of ultimate strength design called the yield line design was developed by G. G. Meyerhof in the 1960's for plain concrete and referenced in ACI 360 Chapter 11 for fiber reinforced concrete. In this method, instead of assuming that a slab fails upon initiation of a first crack, the slab is assumed to fail only when the loads redistribute to the top surface and a circular crack pattern forms around the load. Recently, this method was shown to represent a conservative estimate based on tests performed by A. Alani using large concrete slabs subjected to central, edge, and corner loading.

The use of the yield line method supports the use of thinner, more economical, and more sustainable concrete slabs, thereby, lowering cost and the carbon footprint associated with the construction of the slabs. In fact, the redistribution of stresses as described within the yield line method indicates that the thickness of the slabs can be reduced by about 50%. Testing confirms that plain concrete ground-supported slabs exhibit considerable capacity after the initial crack formation. However, any further reduction in the thickness of a conventional concrete structure has been shown by the yield line method to require the use of bottom (positive moment) reinforcement in the form of rebar to allow for the use of even thinner slabs and lower carbon designs. In comparison, the reinforced vapor barrier of the present disclosure provides enough strength to assure performance of the concrete slab even if bottom cracks occur by providing enough capacity in the plastic hinge area to allow sectional forces to re-distribute to the top surface of the slab even in the event of poor soil.

While the yield line method was developed for plain concrete, best practice in the industry has been to provide reinforcement to the bottom of the concrete slab to assure that loads re-distribute to the top of the concrete slab and that bottom cracks do not reflect to the top of the slab. This reinforcement is conventionally in the form of steel rebar. Thus, no reinforcement is commonly required at the top of the slab. For the use of 4,000 psi concrete, the flexural tensile strength can be approximated to be about 170 psi (=9×sqrt [compressive strength of the concrete]×30%). This equates to about 2,000 lbs tensile capacity per foot in a six inch (15.24 cm) thick slab. The required strength will increase as the thickness of the concrete slab increases and decrease for the use of thinner slabs.

The utilization of rebar is not desirable because it prevents the efficient use of automated finishing equipment, such as a laser screed, due to the need to be moved in order to drive on the surface. In addition, the use of rebar is time consuming and expensive to install given that on-site labor is required. Other alternatives that avoid this problem have been used with varying degrees of success such as fiber reinforced concrete (FRC) and fiber reinforced plastics (FRP) systems. FRP systems are typically used to rehabilitate, repair, or restore the strength of a deteriorated structural member.

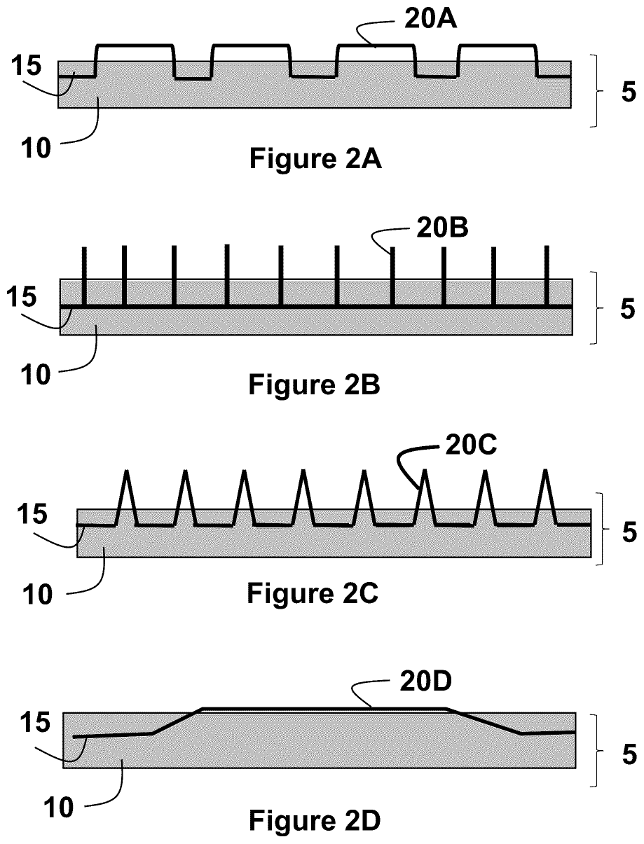

Referring now to FIGS. 2A, 2B, 2C, & 2D, according to one aspect of the present disclosure, the reinforced vapor barrier 5 comprises a polymeric sheet 10 and a continuous reinforcement material 15. The continuous reinforcement material 15 is at least partially embedded within the polymeric sheet 10. However, a portion of the continuous reinforcement material 15 also protrudes from the surface of the polymeric sheet 10. The protruding continuous reinforcement material 20 is present in order to interact with the concrete structure 25A, 25B (best shown in FIGS. 1A & 1B). This interaction enhances the attraction, connection, joining, bonding, or attachment of the reinforced vapor barrier 5 to the concrete structure 25A, 25B.

The polymeric sheet 10 of the present disclosure is permeable to vapor transmission. The polymeric sheet 10 may comprise, but not be limited to, polyethylene (PE), polypropylene (PP), polyethylene terephthalate (PET), synthetic rubbers, or a co-polymer or mixture thereof. The polymeric sheet 10 may have a thickness that is in the range of about 0.10 mm to about 150 mm; alternatively in the range of 0.25 mm to 100 mm; alternatively, greater than 1.0 mm and less than or equal to 75 mm; alternatively between 2.0 mm and 50 mm.

The protruding material 20 may be of any desirable shape, such as for example, without limitation, multiple flat surfaces 20A (see FIG. 2A), pointed surfaces 20C (see FIG. 2C), or a long flat surface 20D (see FIG. 2D). When desirable the protruding material 20 may also take the form of barbs, hooks, spurs, spikes, spines or the like 20B (see FIG. 2B) arising from the surface of the continuous reinforcement material 15. The reinforcement material 15 of the reinforced vapor barrier 5 protrudes at least 1 millimeter (mm) into the concrete structure 25A, 25B; alternatively, the reinforcement material 15 protrudes 1.5 mm or more into the concrete structure; alternatively, the protrusion of the reinforcement material into the concrete structure 25A, 25B is at least 2 mm.

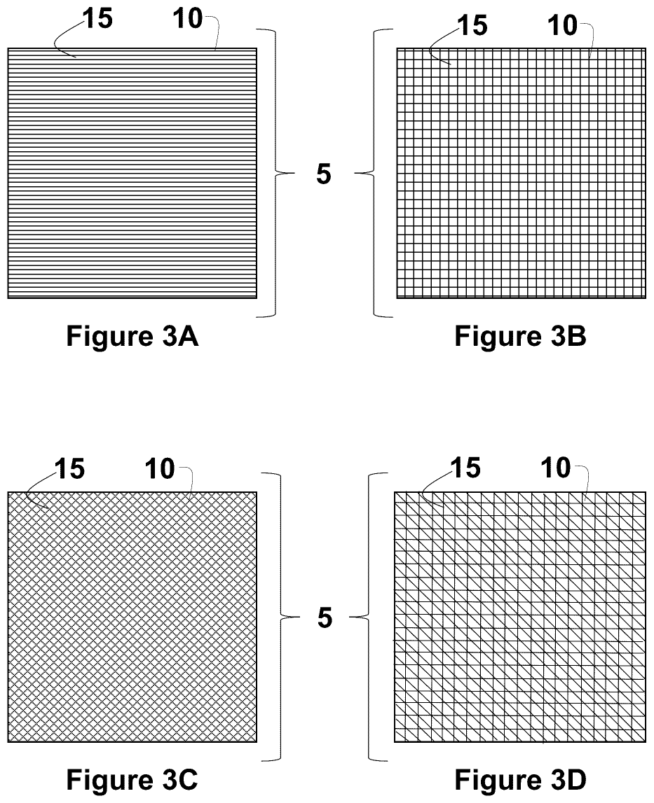

The continuous reinforcement material 15 may comprise a plastic, carbon, and/or metal in the form of a string, a cord, a wire, strips, or the like. For example, the continuous reinforcement material 15 may include, without limitation, synthetic fiber reinforced plastic strings, carbon fiber wires, carbon fiber strips, or metal (e.g., steel, etc.) wires. The continuous reinforcement material 15 may be embedded within the polymeric sheet 10 in any geometric configuration or pattern, including but not limited to, straight or curved lines that are parallel to one another or overlap with each other to form a pattern, such as, for example, a diamond pattern, a square pattern, a rectangular pattern, or a triangular pattern. One skilled in the art will understand that other patterns may be utilized without exceeding the scope of the present disclosure. An example of a reinforced vapor barrier 5 with a continuous reinforcement material 15 in the form of straight lines, a square pattern, a diamond pattern, and a triangular pattern are shown in FIGS. 3A, 3B, 3C, and 3D, respectively. The amount of the continuous reinforcement material 15 incorporated into the reinforced vapor barrier 5, as well as the composition and thickness of the polymeric sheet 10 may be selected based upon the degree of reinforcement and barrier protection required for a given application or concrete structure.

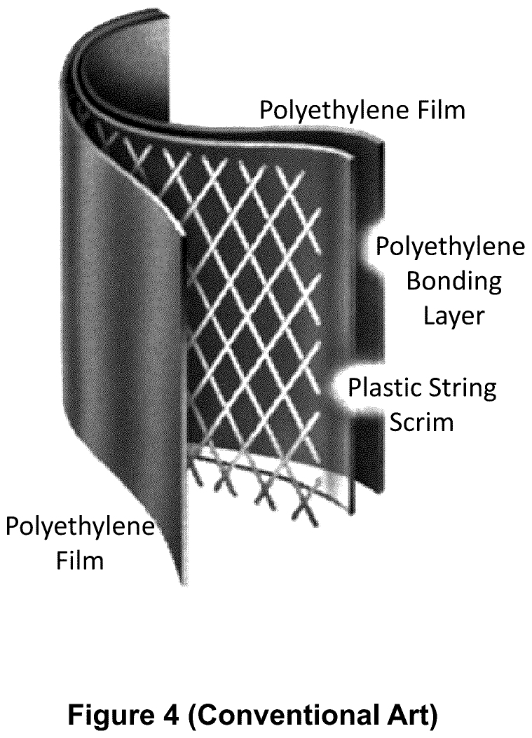

The pattern used for the continuous reinforcement material 15 in the reinforced vapor barrier 5 may be similar to or different from the patterns conventionally found in commercially available string reinforced polymer sheet products, such as Dura Skrim II (Pro-Tect Plastics & Supply, Inc., Oregon) or S-17863 reinforced poly-sheeting roll (Uline Inc., Illinois) to name few. Referring now to FIG. 4, these commercially available string reinforced polymer sheet products generally include a plastic string scrim encapsulated in a polyethylene bonding layer positioned between two polyethylene outer films. The plastic string scrim shown in the conventional product of FIG. 4 represents an example of a diamond pattern.

Multiple differences exist between the commercially available string reinforced polymer sheet product (FIG. 4) and the reinforced vapor barrier 5 of the present disclosure. For example, the plastic string scrim in the commercial products is entirely encapsulated within plastic. Thus, no component of the plastic string scrim in the commercially available string reinforced polymer sheet products protrudes from the surface of the plastic and is capable of interacting with the concrete structure. In addition, the plastic sheet in the commercial products is extremely thin having a thickness that is only on the order of 6-10 mils (0.15-0.25 mm). Furthermore, the tensile strength of these commercial string reinforced polymer sheet products are also extremely low. More specifically, the commercial products exhibit a tensile strength of approximately 500 lbs/ft, which is only about 25% of the required strength necessary for use as a reinforced vapor barrier.

In comparison, the strength of the reinforced vapor barrier 5 of the present disclosure exhibit a tensile strength that is ~2,000 lbs per foot or greater; alternatively, at least 2000 lbs/ft; alternatively 2,500 lbs/ft or more; alternatively, 3,000 lbs per foot or greater; alternatively, about 4,000 lbs/ft. The reinforced vapor barrier 5 according to the present disclosure may have a greater thickness than commercially available string reinforced polymer sheet products, contain a greater amount of a reinforcement material or incorporate a reinforcement material with a higher tensile strength. Given that most concrete slabs have 4,000 psi compressive strength, reinforcement vapor barriers can be made with the appropriate tensile strength based on the thickness of 4″, 6″, 8″ and 12″ for the concrete slab.

The continuous reinforcement material 15 used in the reinforced vapor barrier 5 of the present disclosure may be formed of the same or similar material as currently used for chopped synthetic fibers that are known to be randomly mixed into concrete for various applications. This type of material generally includes a polypropylene/polyethylene (PP/PE) mixture or a co-polymer formed with polypropylene (PP). These polypropylene mixtures and co-polymers exhibit high tensile strength (e.g., over 80 ksi) and are available at a relatively low cost. One specific example, of such material is the polypropylene and polyethylene synthetic macrofibers commercially available as Tuf-Strand™ SF (Euclid Chemical, Ohio). In addition, these mixtures and co-polymers are presently optimized for bonding with fresh concrete. In the reinforced vapor barrier 5 of the present disclosure the use of continuous polymeric strands placed below the concrete slab could effectively be utilized in the yield line design given that reinforcement is only required at the bottom of or below the slab.

In order for the reinforced vapor barrier 5 of the present disclosure to be effective, it would need to effectively interact with the concrete structure 1. This interaction may be accomplished by incorporating the reinforcement material protruding from the surface of the sheet into the concrete structure, such that the reinforcement material interacts, bonds, etc. with the concrete structure 1. The strength of this bond would need to be equal to or greater than the required tensile strength (e.g., at least 2,000 lbs per foot) as previously discussed above. When desirable, the interaction between the reinforcement material 15 and the concrete structure 1 can be further enhanced by impregnating the surface of the protruding reinforcement material 20 with a glue or adhesive that activates when it comes into contact with fresh concrete, thereby, forming a chemical bond with the surface.

When desirable, the reinforced vapor barrier 5 may further comprise one or more semi-rigid supports. These semi-rigid supports may be positioned, such that they assist the continuous reinforcement material 15 to interact with the concrete structure 35.

According to another aspect of the present disclosure, a concrete structure 1 is provided that comprises concrete having a surface with a reinforced vapor barrier 5 attached thereto as previously described herein and further defined here after. The concrete structure 1 may have a minimum thickness of 1.25 mm; alternatively, the thickness of the concrete structure 1 is at least 2.0 mm; alternatively, between about 1.25 mm to about 300 mm; alternatively, about 100 mm; alternatively, about 150 mm; alternatively, about 200 mm; alternatively, about 250 mm; alternatively, about 300 nm.

The concrete structure 1 may be formed from plain concrete or concrete reinforced with twisted bilateral truncated circular-shaped discontinuous reinforcements dispersed within the concrete matrix. This twisted bilateral truncated circular shaped metal discontinuous reinforcement may be a plurality of twisted steel fibers. One specific example of such discontinuous twisted steel fibers that are dispersible within a concrete matrix is the twisted steel micro-rebar (TSMR) commercially available from Pensmore Reinforcement Technologies (Michigan) as Helix® Micro Rebar®. When desirable the concrete structure may also include one or more of steel rebar, a welded wire mesh, and/or a fiber reinforced plastic bar reinforcement.

The concrete structure 1 formed according to the present disclosure exhibits a flexural strength and the reinforced vapor barrier provides a positive moment with a capacity that is at least equal to 30% of the concrete's flexural strength. Alternatively, this capacity is at least equal to 40% of the concrete's flexural strength; alternatively, at least equal to 50% of the concrete's flexural strength.

One skilled in the art will understand that the concepts presented herein may be modified without exceeding the scope of the present disclosure in order to address various issues commonly encountered during the construction of a concrete structure. For example, over-reinforcing saw cut joints is known to cause a variety of issues. These issues may be minimized using the reinforced vapor barrier concept provided above and further defined herein by selecting a low modulus continuous reinforcement material for use in or near saw cut joints. In this respect, the reinforced vapor barrier would be capable of being stretched at such joints. In addition, the reinforced vapor barrier 5 could also be jointed at or near the saw cut locations in order to weaken said barrier layer in that area.

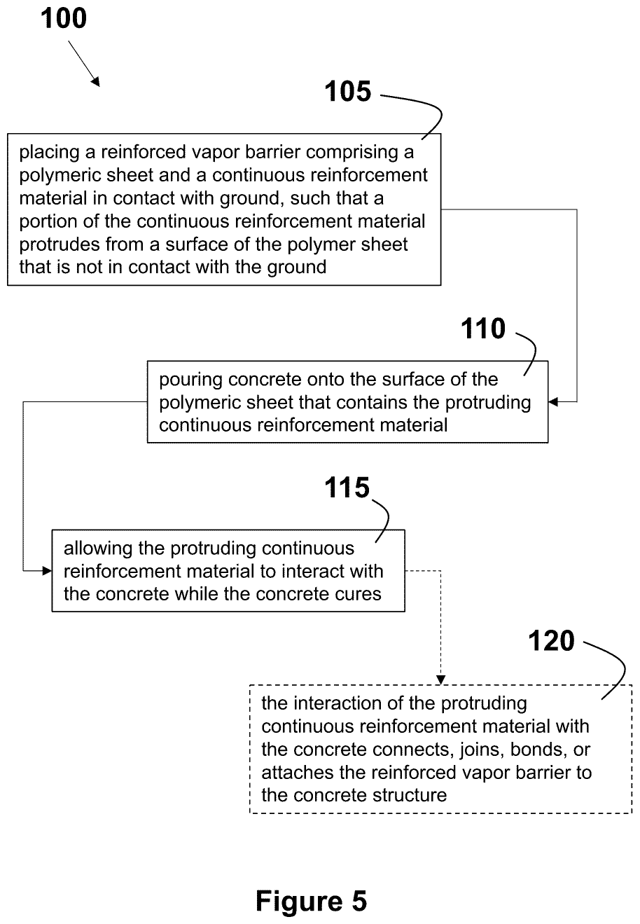

According to another aspect of the present disclosure, a method of forming a concrete structure having a surface with a reinforced vapor barrier is provided. Referring now to FIG. 5, this method 100 comprises the following steps. A reinforced vapor barrier comprising a polymeric sheet and a continuous reinforcement material as previously described above and as further defined herein is placed 105 in contact with ground. In this sense, the phase “contact with ground” may include direct contact with the earth or soil or indirect contact with the earth or soil if and/or when an optional compacted sublayer is placed between the reinforced vapor barrier and the earth or soil. The reinforced vapor barrier is placed 105 in contact with ground, such that the portion of the continuous reinforcement material that protrudes from a surface of the polymer sheet is not in contact with the ground.

Then, concrete is poured 110 onto the surface of the polymeric sheet that contains the protruding continuous reinforcement material. The protruding continuous reinforcement material is allowed 115 to interact with the concrete as the concrete cures. The interaction of the protruding continuous reinforcement material with the concrete connects, joins, bonds, or attaches 120 the reinforced vapor barrier to the concrete structure.

For the purpose of this disclosure the terms “about” and “substantially” are used herein with respect to measurable values and ranges due to expected variations known to those skilled in the art (e.g., limitations and variability in measurements).

For the purpose of this disclosure, the terms “at least one” and “one or more of” an element are used interchangeably and may have the same meaning. These terms, which refer to the inclusion of a single element or a plurality of the elements, may also be represented by the suffix “(s)” at the end of the element. For example, “at least one metal”, “one or more metals”, and “metal(s)” may be used interchangeably and are intended to have the same meaning.

Furthermore, any range in parameters that is stated herein as being “between [a 1^{st} number] and [a 2^{nd} number]” or “between [a 1^{st} number] to [a 2^{nd} number]” is intended to be inclusive of the recited numbers. In other words, the ranges are meant to be interpreted similarly as to a range that is specified as being “from [a 1^{st} number] to [a 2^{nd} number]”.

The specific examples provided in this disclosure are given to illustrate various embodiments of the invention and should not be construed to limit the scope of the disclosure. The embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Those skilled-in-the-art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and can be obtained by multiple different methods. The methods described herein represent one such method and other methods may be utilized without exceeding the scope of the present disclosure.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A reinforced vapor barrier for application to a concrete structure, the reinforced vapor barrier comprising a polymeric sheet and a continuous reinforcement material;
wherein the continuous reinforcement material is at least partially embedded within the polymeric sheet with a portion thereof protruding from a surface of the polymeric sheet, such that the protruding reinforcement material interacts with the concrete structure.

2. The reinforced vapor barrier according to claim 1, wherein the continuous reinforcement material comprises a plastic, carbon, and/or metal in the form of a string, a cord, a wire, or strips.

3. The reinforced vapor barrier according to claim 2, wherein the continuous reinforcement material includes a synthetic fiber reinforced plastic string, a carbon fiber wire, carbon fiber strips, or a steel wire.

4. The reinforced vapor barrier according to claim 1, wherein the polymeric sheet is permeable to vapor transmission there through.

5. The reinforced vapor barrier according to claim 1, wherein the reinforced vapor barrier further comprises one or more semi-rigid supports, the semi-rigid supports being positioned such that they assist the continuous reinforcement material in interacting with the concrete.

6. The reinforced vapor barrier according to claim 1, wherein the continuous reinforcement material protrudes at least 1 millimeter (mm) into the concrete structure.

7. The reinforced vapor barrier according to claim 1, wherein the polymeric sheet comprises polyethylene (PE), polypropylene (PP), polyethylene terephthalate (PET), synthetic rubbers, or a copolymer or mixture thereof.

8. The reinforced vapor barrier according to claim 1, wherein the polymeric sheet has a thickness that is in the range of about 0.25 mm to 100 mm.

9. A concrete structure comprising concrete having a surface with a reinforced vapor barrier according to claim 1 applied to at least a portion of the surface.

10. The concrete structure according to claim 9, wherein the concrete has a minimum thickness of 1.25 mm.

11. The concrete structure according to claim 9, wherein the reinforced vapor barrier is placed on the surface of the concrete, such that the reinforced vapor barrier separates the surface of the concrete from the ground.

12. The concrete structure according to claim 9, wherein the concrete includes a twisted bilateral truncated circular shaped metal discontinuous reinforcement incorporated therein.

13. The concrete structure according to claim 12, wherein the twisted bilateral truncated circular shaped metal discontinuous reinforcement is a plurality of twisted steel fibers.

14. The concrete structure according to claim 9, wherein the concrete exhibits a flexural strength and the reinforced vapor barrier provides a positive moment with a capacity that is at least equal to 30% of the concrete's flexural strength.

15. The concrete structure according to claim 9, wherein the concrete exhibits a flexural strength and the reinforced vapor barrier provides a positive moment with a capacity that is at least equal to 50% of the concrete's flexural strength.

16. The concrete structure according to claim 9, wherein the concrete structure further comprises one or more of steel rebar, a welded wire mesh and/or a fiber reinforced plastic bar reinforcement.

17. A method of forming a concrete structure having a surface with a reinforced vapor barrier, the method comprising:
placing a reinforced vapor barrier comprising a polymeric sheet and a continuous reinforcement material according to claim in contact with ground, such that a portion of the continuous reinforcement material protrudes from a surface of the polymer sheet that not in contact with the ground;
pouring concrete onto the surface of the polymeric sheet that contains the protruding continuous reinforcement material; and
allowing the protruding continuous reinforcement material to interact with the concrete while the concrete cures.

18. The method according to claim 17, wherein the interaction of the protruding continuous reinforcement material with the concrete connects, joins, bonds, or attaches the reinforced vapor barrier to the concrete structure.

19. The reinforced vapor barrier according to claim 3, wherein the polymeric sheet is permeable to vapor transmission there through, the polymeric sheet comprising polyethylene (PE), polypropylene (PP), polyethylene terephthalate (PET), synthetic rubbers, or a copolymer or mixture thereof; the polymeric sheet having a thickness that is in the range of about 0.25 mm to 100 mm;
wherein the reinforced vapor barrier further comprises one or more semi-rigid supports, the semi-rigid supports being positioned such that they assist the continuous reinforcement material in interacting with the concrete, the continuous reinforcement material protruding at least 1 millimeter (mm) into the concrete structure.

20. A concrete structure comprising concrete having a surface with a reinforced vapor barrier according to claim 19 applied to at least a portion of the surface, such that the reinforced vapor barrier separates the surface of the concrete from the ground;
wherein the concrete has a minimum thickness of 1.25 mm and includes a plurality of twisted bilateral truncated circular shaped metal discontinuous reinforcements incorporated therein, such that the concrete exhibits a flexural strength and the reinforced vapor barrier provides a positive moment with a capacity that is at least equal to 30% of the concrete's flexural strength.
